(19) United States
(12) Patent Application Publication
(10) Pub. No.: US 2006/0195847 A1
(43) Pub. Date: Aug. 31, 2006

(54) Task scheduling device, method, program, recording medium, and transmission medium for priority-driven periodic process scheduling

(76) Inventors: Katsushige Amano, Kyoto-shi (JP); Masashige Mizuyama, Neyagawa-shi (JP)

Correspondence Address: WENDEROTH, LIND & PONACK L.L.P., 2033 K. STREET, NW, SUITE 800, WASHINGTON, DC, 20006, US

(21) Appl. No.: 10/563,060

(22) PCT Filed: Dec. 3, 2004
(86) PCT No.: PCT/JP04/18422

§ 371 Date: Jan. 3, 2006

(30) Foreign Application Priority Data
Dec. 4, 2003 (JP) 2003-405376

(51) Int. Cl. G06F 9/46

(52) U.S. Cl. 718/103

(57) ABSTRACT

A high priority setter 102 writes the first priority (high priority) of a specific task #1 recorded in a specific task table 110 every time interval T, as the priority of the task #1 in a task priority table 111. Thereafter, when a time duration TH shorter than the time interval T elapsed, a low priority setter 103 writes the second priority (low priority) of the specific task #1 recorded in the specific task table 110, as the priority of the task #1 in the task priority table 111. The second priority is set lower than the first priority. A task selector 101 selects a task whose priority is set the highest among the tasks 10 recorded in the task priority table 111, as a specific task to be executed. Thus, the processing of the specific task #1 is securely executed during the time duration TH every time interval T, and the execution of the specific task #1 is allowed to continue if it is judged that there is no other task to be executed during the rest of the time interval T other than the time duration TH, by setting the first priority sufficiently high.

### TECHNICAL FIELD

The present invention relates to a task scheduling device for performing task scheduling in a multitask environment, a task scheduling method, a task scheduling program, a recording medium, and a transmission medium.

### BACKGROUND ART

Computers have been utilized not only in the form of apparatus whose primary purpose is information processing, such as large-scaled computers and personal computers, but also in the form of applied devices such as various consumer electronic devices, and mobile phones. Some of the consumer electronic devices loaded with a computer are required to perform a predetermined processing every predetermined time interval. In case of handling streaming video or audio data, frames of the streaming data are designed to be processed every predetermined time unit, e.g., 10 ms. In such a case, unless necessary data processing is executed with respect to each of the frames within a predetermined time, continuous video or audio output is not performed.

It is possible to cause a multitask computer to execute a predetermined processing every predetermined time interval by setting the priority of a task performing the processing sufficiently high. For instance, Japanese Unexamined Patent Publication No. 4-335441 discloses a technique of securing responsiveness to a command by fixedly setting the priority of a process responding to an inputted command high for a certain time duration.

In case of handling streaming data, processing of data of an amount exceeding a certain amount is not indispensable, although it is required to process data of a predetermined amount corresponding to each frame. In some cases, it is desirable to execute a task other than the ongoing task, once processing of data of a minimum required amount is completed with respect to the ongoing task. For instance, a user may feel uncomfortable if start of execution of a task is exceedingly delayed in response to an input entered by the user. In view of this, it is desirable that the task of responding to the input be executed immediately or shortly after completion of the processing of data of the minimum required amount in order to secure continuous video or audio output. Particularly, in the case where a specific task is executed with a high priority in the arrangement disclosed in the above publication, a task of priority lower than the priority of the specific task is not executed at all during which the specific task of high priority is executed.

There may be suggested a technique of cyclically putting a task of high priority to sleep in a normal state and wakening up the task in an attempt to avoid such a drawback. However, in such a technique, it is impossible for a specific task that is controlled to wake up and sleep cyclically to be executed while it is put to sleep. Specifically, in a circumstance that processing of the other task(s) is not required while the specific task is put to sleep, there is a blank time when no active task exists, which hinders efficient use of the resource of a CPU.

### DISCLOSURE OF THE INVENTION

In view of the above problems residing in the prior art, an object of the present invention is to provide a task scheduling technology that enables to realize processing of a task to be prioritized and a task of lower priority in a well-balanced manner, while effectively utilizing the resource of a CPU.

One aspect of the present invention is directed to a task scheduling device for realizing a multitask processing by performing scheduling of a plurality of tasks, the device comprising: a task selector which selects a task of the highest priority among the plurality of tasks, as a task to be executed; a high priority setter which cyclically sets the priority of a specific task among the plurality of tasks to a first predetermined priority every predetermined time interval T; and a low priority setter which cyclically sets the priority of the specific task to a second predetermined priority lower than the first priority before the time interval T elapses and after the priority of the specific task is set to the first priority by the high priority setter.

These and other objects, features, aspects, and advantages of the present invention will become more apparent upon reading of the following detailed description and accompanying drawings.

### BRIEF DESCRIPTION OF THE DRAWINGS

FIG. 1 is a block diagram showing a configuration of a task scheduling device according to a first embodiment of the present invention.

FIG. 2 is a flowchart showing a flow of main processing by the device shown in FIG. 1.

FIG. 3 is a timing chart for explaining an exemplary processing by the device shown in FIG. 1.

FIG. 4 is a block diagram illustrating a specific example of the device shown in FIG. 1.

FIG. 5 is a timing chart for explaining a processing by the device shown in FIG. 4.

FIG. 6 is a timing chart for explaining a processing by the device shown in FIG. 4.

FIG. 7 is a timing chart showing a comparative example to the example shown in FIGS. 5 and 6.

FIG. 8 is a timing chart showing a comparative example to the example shown in FIGS. 5 and 6.

FIG. 9 is a timing chart showing a comparative example to the example shown in FIGS. 5 and 6.

FIG. 10 is a block diagram showing a modification of the device shown in FIG. 1.

FIG. 11 is a block diagram showing a configuration of a task scheduling device according to a second embodiment of the present invention.

FIG. 12 is a block diagram exemplifying an arrangement relating to a processing of switching the priority of a specific task from a high priority to a low priority.

FIG. 13 is a flowchart showing a flow of main processing by the device shown in FIG. 11.

FIG. 14 is a timing chart for explaining an exemplified processing by the device shown in FIG. 11.

FIG. 15 is a block diagram exemplifying a modification of the device shown in FIG. 11.

FIG. 16 is a block diagram exemplifying a modification of the device shown in FIG. 11.

FIG. 17 is a block diagram exemplifying a modification of the device shown in FIG. 11.

FIG. 18 is a block diagram exemplifying a modification of the device shown in FIG. 11.

### BEST MODE FOR CARRYING OUT THE INVENTION

In the following, preferred embodiments of the present invention are described referring to the drawings.

### First Embodiment

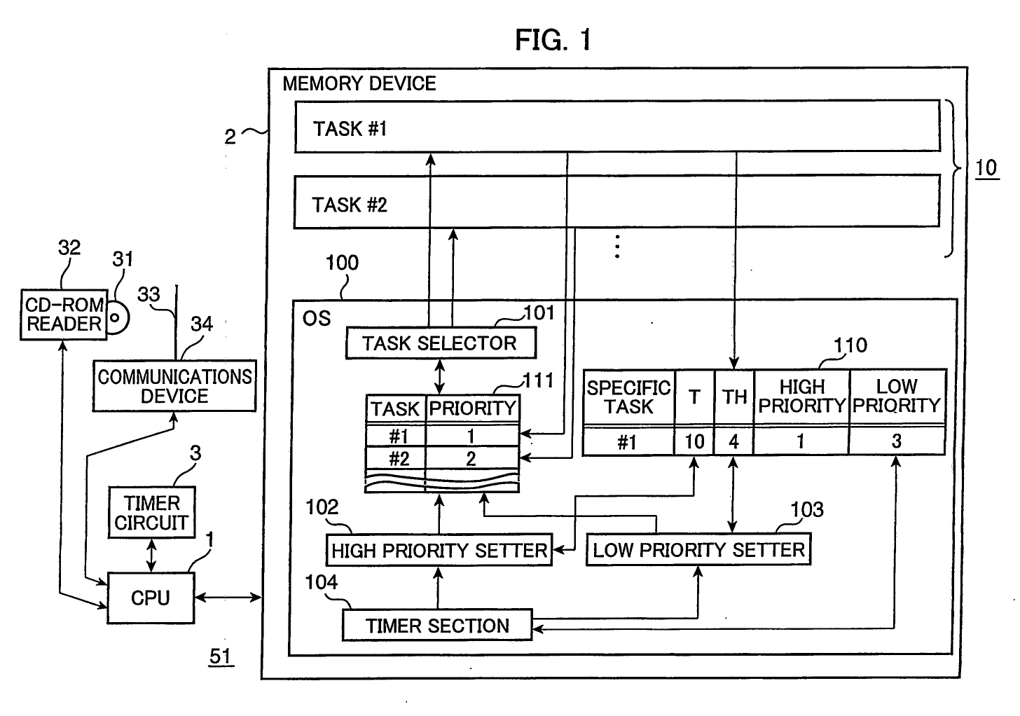

FIG. 1 is a block diagram showing a configuration of a task scheduling device according to a first embodiment of the present invention. The task scheduling device 51 constitutes part of a computer. The computer comprises at least one central processing unit (CPU) 1, a memory device 2, and a timer circuit 3. The computer may be provided with other devices such as an input device and an output device, although illustration of these devices is omitted herein.

As far as sufficient processing performance is assured, any type of CPU is usable. The memory device 2 stores therein one or more tasks 10, and programs and data including an operating system (OS) 100 of the computer. Individual tasks #1, #2, . . . included in the task 10 may be a single program, i.e., a process, or a thread that is part of the program. As far as the memory device 2 has a sufficient function and storage capacity, any type of memory device such as a random access memory (RAM) or a flash memory is usable. The memory device 2 may be a combination of memory devices of the same type, or a combination of memory devices of different types including a read only memory (ROM), as well as a single memory device. The computer may be equipped with an external storage device such as a hard disk, other than the memory device 2, or may be configured such that programs and data are transferable to an external storage device, as long as such data transfer does not hinder the operation of the computer.

It is possible to supply the programs and the data by way of a recording medium 31 such as an ROM, a flexible disk, or a CD-ROM, or through a transmission medium 33 such as a telephone line or a network. FIG. 1 depicts a CD-ROM as the recording medium 31, and a telephone line as the transmission medium 33. The programs and the data recorded on the CD-ROM can be read out therefrom by connecting a CD-ROM reader 32 as an external device of the computer with a main body of the computer for storage in an RAM or an unillustrated hard disk, for example. In the case where the programs and the data are supplied in the form of an ROM as the recording medium 31, the computer can execute processing based on the programs and the data by loading the ROM in the computer. In this case, the ROM is included in the memory device 2. The programs and the data supplied through the transmission medium 33 are received in the computer through a communications device 34, and stored in an RAM or an unillustrated hard disk, for example. The transmission medium 33 may be a wired transmission medium or a wireless transmission medium.

The individual tasks #1, #2, . . . included in the task 10 each have a priority in a similar manner as tasks to be managed by a general multitask computer, and are processed in parallel with each other in a time-sharing manner in the order of priority. In FIG. 1, the respective tasks are represented by #1, #2, . . . , and #N where N is a positive integer.

The OS 100 includes, as primary components, a task selector 101, a high priority periodical setting section 102 (hereinafter, simply referred to as “high priority setter 102”), and a low priority periodical setting section 103 (hereinafter, simply referred to as “low priority setter 103”) to realize the task scheduling device 51 in cooperation with the CPU 1.

The task selector 101 schedules the task 10 depending on the priority given to each task 10 in a similar manner as a scheduling device using a general priority order. Specifically, the task selector 101 selects a task of a highest priority, and processes the task 10 from the highest priority by causing the CPU 1 to execute the selected task. The task selector 101 not only performs task scheduling unique to the present embodiment in association with the high priority setter 102 and the low priority setter 103, but also performs general task scheduling using a general priority order, independently of the task scheduling unique to the present embodiment. In view of this, the task selector 101 is called appropriately according to need.

The high priority setter 102 sets the priority of a specific task (in this example, the task #1) sufficiently high every predetermined time interval T. Throughout the present specification, the term “sufficiently high priority” means a priority which is assigned to a task whose execution is essentially prioritized over the other tasks while the priority is given to the task. For instance, the sufficiently high priority may be a maximal value in the range of priorities handled by the OS 100. It should be noted that there is a task to be prioritized over a specific task to which the unique task scheduling method according to the present embodiment applied, depending on the design of a computer-applied system. If such a circumstance occurs, it is necessary to give a priority lower than the highest priority to the specific task. It may be possible to classify the priority range into a first range of priorities which are assigned to general tasks, and a second range of priorities which are assigned to tasks whose processing is to be prioritized, and to use the priority in the second range assigned to tasks whose processing is to be prioritized, as the sufficiently high priority. The value of the priority may be set depending on the demand of the device. There is known an operating system using other parameter such as a scheduling class in combination with the priority for task scheduling. The setting of the priority throughout the embodiments and the claims of the present invention embraces setting of such other parameter.

The lower priority setter 103 sets the priority of the task #1 sufficiently low upon lapse of predetermined time duration TH after the priority of the task #1 is set high by the high priority setter 102. Throughout the present specification, the term “sufficiently low priority” means a priority assigned to a task which is conceived that delay of processing thereof does not significantly affect the overall operation of the system. For instance, in the case where the priority range is classified into a first range of priorities which are assigned to general tasks, and a second range of priorities which are assigned to tasks whose processing is to be prioritized, it may be possible to use the priority in the first range assigned to general tasks as the sufficiently low priority. The value of the priority may be set depending on the demand of the system.

The processing of the task #1 whose priority is set low is allowed to continue as long as it is judged that there is no other task whose priority is higher than the priority of the task #1. If it is judged that there is a task whose priority is higher than the priority of the task #1, scheduling by the task selector 101 is performed to execute the processing of the task other than the task #1.

The task scheduling device 51 is configured in the following manner to boot the high priority setter 102 and the low priority setter 103 at their respective predetermined timings. The high priority setter 102 can be realized as an interrupt handler which executes processing in response to timer interrupt by the timer circuit 3. Specifically, the task scheduling device 51 is configured such that the timer circuit 3 interrupts the CPU 1 every time interval T by sending an interrupt request signal to the CPU 1, and that the high priority setter 102 as the interrupt handler is booted to change the priority of the task #1 in response to the interrupt request signal.

Similarly to the high priority setter 102, the low priority setter 103 can be realized as an interrupt handler which executes processing in response to timer interrupt by the timer circuit 3. Specifically, the timer circuit 3 interrupts the CPU 1 upon lapse of time duration TH after the interrupt of booting the high priority setter 102 so as to boot the low priority setter 103. In other words, the timer circuit 3 sends to the CPU 1 two different kinds of interrupt request signals to individually boot the high priority setter 102 and the low priority setter 103.

As an altered form, as shown in FIG. 1, the task scheduling device 51 may be configured such that a timer section 104 is provided in the OS 100, and that the timer section 104 boots the high priority setter 102 every time interval T, and boots the low priority setter 103 at a timing delayed by a time duration TH after the timing of booting the high priority setter 102. In such an altered arrangement, the timer section 104 can be realized as an interrupt handler which executes processing in response to timer interrupt by the timer circuit 3, for example. Specifically, the timer circuit 3 interrupts the CPU 1 every time interval T0 (e.g., one-hundredth of the time interval T), which is sufficiently shorter than the time interval T, and the timer section 104 has a counter of counting up the time every time interval T0. The timer section 104 boots the high priority setter 102, and resets the counted value to zero when the counted value reaches the time interval T. Further, the timer section 104 boots the low priority setter 103 each time when the counted value reaches the duration TH.

In the case where the high priority setter 102 and the low priority setter 103 are realized as interrupt handlers, the timer section 104 is not necessary.

The OS 100 has a specific task table 110 and a task priority table 111, for instance, to enable the high priority setter 102 and the low priority setter 103 to set the priority of a specific task. The specific task table 110 is a table in which parameters for realizing the scheduling unique to the present embodiment are recorded in correlation with a specific task (in the example of FIG. 1, the task #1). The contents to be recorded in the specific task table 110 include an indicator (hereinafter, tentatively called as “specific task indicator”) for identifying the specific task, the time interval T, the time duration TH, a high priority, and a low priority.

The high priority and the low priority to be recorded in the specific task table 110 respectively mean a high priority and a low priority which are assigned to a specific task in the scheduling unique to the present embodiment. In the following, for the sake of explanation, the symbol “#1” represents a specific task indicator identifying the task #1, the time interval T is 10 ms, the time duration TH is 4 ms, the high priority is priority “1”, and the low priority is priority “3”. In this embodiment, the smaller the value of the priority is, the higher the priority is, and the priority “1” indicates that the priority is the highest. The order of priority is not limited to the above. In the embodiment, as far as judgment as to whether the priority is high or low is executable, the priority can be expressed in an arbitrary manner. This idea is not only applicable to the example shown in FIG. 1 but also applicable to all the examples shown by the drawings other than FIG. 1.

The task priority table 111 is a table in which the respective priorities of tasks included in the task 10 are recorded in correlation with the corresponding tasks. The contents to be recorded in the task priority table 111 include indicators (hereinafter, tentatively called as “task indicators”) for identifying the respective tasks, and priorities. The task selector 101 selects a task of the highest priority among all the priorities recorded in the task priority table 111 by referring to the task priority table 111. In the following, for the sake of explanation, the priority of the task #1 is “1”, and the priority of the task #2 is “2”, respectively.

The contents in the specific task table 110 are recorded therein by allowing a task to send a request to the OS 100 for recording the contents when time comes that the task is judged to be handled as the specific task in the scheduling unique to the present embodiment after the task is written in the memory device 2. Further, when time comes that the specific task recorded in the specific task table 110 is judged to be no longer handled as the specific task in the scheduling unique to the present embodiment, the recorded contents are erased from the specific task table 110 by allowing the specific task to send a request to the OS 100 for erasing the recorded contents.

For instance, when time comes that the task #1 is to be handled as a specific task after the task #1 is written in the memory device 2, the contents relating to the task #1 are written in the specific task table 110. Further, when the time that the task #1 is to be handled as the specific task is over, the contents relating to the task #1 are erased from the specific task table 110. In this way, the contents in the specific task table 110 are rewritable at an appropriate timing.

On the other hand, the contents to be recorded in the task priority table 111 are recorded therein when a new task is written in the memory device 2, or at an appropriate timing after the new task is written in the memory device 2 and before the process inherent to the new task is executed for the first time, by allowing the new task to send a request to the OS 100 for recording the contents relating to the new task. For instance, if the task #1 and the task #2 are written in the memory device 2, the contents relating to the task #1 and the task #2 are recorded in the task priority table 111. Thereafter, when a new task #3 is written in the memory device 2, the contents relating to the new task #3 are recorded in the task priority table 111.

Recording of the contents into the specific task table 110 and the task priority table 111 is realized by providing in the OS 100 a system call that enables rewriting of the contents in association with the specific task table 110 and the task priority table 111. Specifically, when the task #1 calls the system call associated with the specific task table 110 to deliver to the system call the contents to be recorded such as the specific task indicator and the time interval T as arguments, the system call records the delivered contents in the specific task table 110. Further, when the task #1 calls the system call associated with the task priority table 111 to deliver to the system call the contents to be recorded as arguments, the system call records the contents in the task priority table 111.

The timer section 104 refers to the specific task table 110 every time interval T0, and acquires the time interval T and the time duration TH if it is judged that there is a record relating to the specific task in the specific task table 110. As mentioned above, the timer section 104 boots the high priority setter 102, and resets the counted value to zero each time when the counted value reaches the time interval T, and boots the low priority setter 103 each time when the counted value reaches the time duration TH.

The booted high priority setter 102 acquires the specific task indicator “#1” and the high priority “1” by referring to the specific task table 110. Subsequently, the high priority setter 102 rewrites the priority “1” assigned to the task #1 which is identified by the acquired specific task indicator “#1” in the task priority table 111 to the acquired high priority “1”. In the example of FIG. 1, the priority remains the same before and after the rewriting.

The booted low priority setter 103 acquires the specific task indicator “#1” and the low priority “3” by referring to the specific task table 110. Subsequently, the low priority setter 103 rewrites the priority “1” assigned to the task #1 which is identified by the acquired specific task indicator “#1” in the task priority table 111 to the acquired low priority “3”.

The high priority setter 102 stores an initial value of the priority, which is the value of the priority recorded in the task priority table 111 before rewriting the contents in the task priority table 111, in a separate column of the task priority table 111, for instance, exclusively when the high priority setter 102 is booted for the first time during a series of booting procedures which are executed every time interval T. The timer section 104 does not boot either the high priority setter 102 or the low priority setter 103 when it is judged that there is no record in the specific task table 111, as a result of retrieval operation from the specific task table 110 every time interval T0. However, the timer section 104 shifts the initial value “1” of the priority stored in the task priority table 111 to the priority “1” assigned to the task #1 by booting the high priority setter 102, for example, exclusively when it is judged that there is no record relating to the specific task in the specific task table 110, as a result of retrieval operation from the specific task table 110 every time interval T0.

The task selector 101 realizes the time scheduling unique to the present embodiment, and the general time scheduling based on the initial value of the priority appropriately according to needs of the task 10 with use of the task scheduling device 51 having the above configuration.

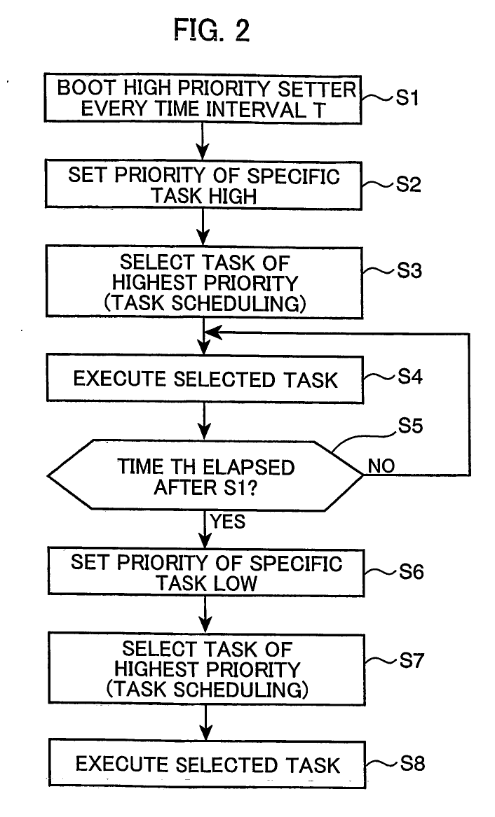

FIG. 2 is a flowchart showing a flow of main processing in performing the task scheduling unique to the present embodiment. Description is made on the premise that the parameters such as the specific task indicator are recorded in the specific task table 110, with the task #1 being designated as the specific task.

In Step S1, the timer section 104 boots the high priority setter 102. Thereby, the high priority setter 102 initiates its processing. As described above, the high priority setter 102 may be booted by timer interrupt by the timer circuit 3. As described above, the processing of Step S1 is executed every time interval T.

Next, in Step S2, the high priority setter 102 sets the priority of the specific task (task #1) high by referring to the specific task table 110. Specifically, the high priority setter 102 rewrites the priority of the specific task (task #1) in the task priority table 111 to the high priority recorded in the specific task table 110.

Subsequently, the task selector 101 performs scheduling of the task 10 according to the contents in the task priority table 111 (Step S3). Since the priority of the task #1 is set sufficiently high in Step S2, the task selector 101 normally selects the task #1 as a task to be executed.

In Step S4, the CPU 1 executes the task selected by the task selector 101. Then, the timer section 104 judges whether the time duration TH elapsed from the execution of Step S1 (Step S5). Until the time duration TH elapses, execution of the task (task #1) selected in Step S3, i.e., the processing of Step S4 is continued. When the time duration TH elapsed, the low priority setter 103 is booted by the timer section 104, for example (Step S6) to set the priority of the task #1 low. Specifically, the low priority setter 103 rewrites the priority (high priority) of the specific task (task #1) in the task priority table 111 to the low priority recorded in the specific task table 110.

Then, in Step S7, the task selector 101 performs scheduling of the task 10. Since the priority of the task #1 is set low in Step S6, the task selector 101 selects a task of priority higher than the priority of the task #1, if it is judged that there exists such a task. On the other hand, if it is judged that there is no other task of priority higher than the priority of the task #1, the task selector 101 continues to select the task #1 as the task to be executed. Subsequently, in Step S8, the CPU 1 executes the task selected by the task selector 101. As mentioned above, the processing of Steps S1 through S8 are cyclically repeated every time interval T while the parameters relating to the specific task are recorded in the specific task table 110.

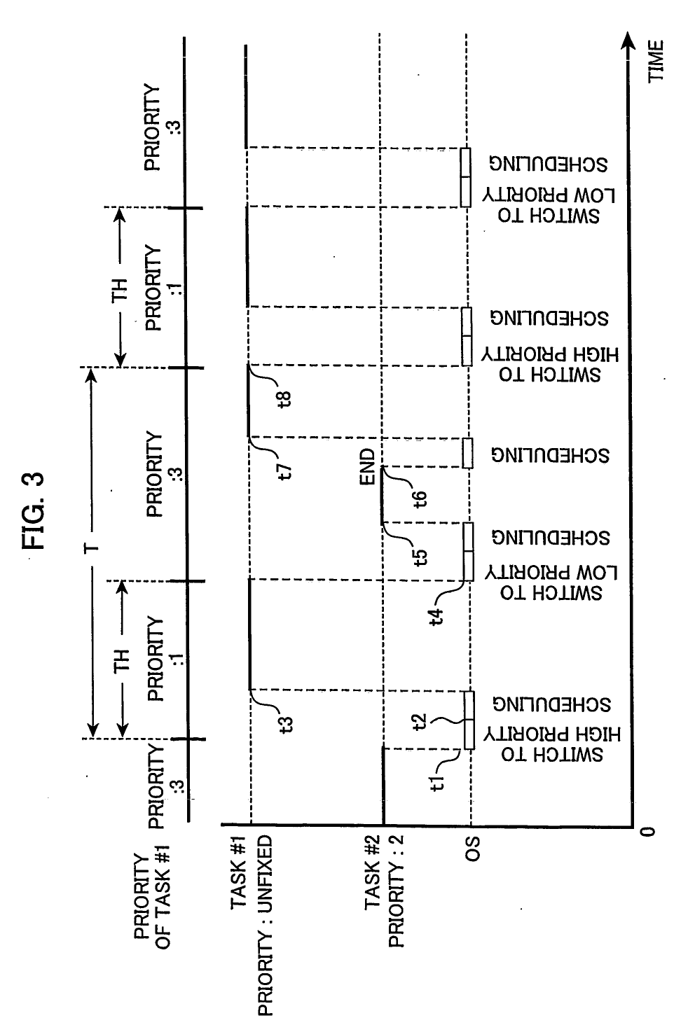

FIG. 3 is a timing chart for explaining an exemplified processing in the embodiment. In the example of FIG. 3, there are two tasks, namely, task #1 and task #2 in the memory device 2, as the task 10. Further, the contents in the specific task table 110 and the initial contents in the task priority table 111 are as illustrated in FIG. 1. Under the above circumstances, the task #1 is a specific task to which the scheduling unique to the embodiment is applied. Although the priority of the task #1 to be recorded in the task priority table 111 is changed from time to time, description is made on the premise that the priority “3” corresponding to the low priority is assigned to the task #1 at the time 0. The task #2 is a general task, namely, a task other than the specific task, and the priority “2” is fixedly assigned to the task #2, and recorded in the task priority table 111 as such. In FIG. 3, the bold solid line represents that the relevant task is executed by securing the CPU 1, and the blank line segment represents that the processing of the OS 100 is executed by the CPU 1.

At the time 0, the task #2 of the priority “2” which is higher than the priority “3” assigned to the task #1 is executed. However, by execution of Steps S1 and S2 in FIG. 2 at the time t1, the priority of the task #1 is set high. Further, at the time t2, the processing of Step S3, i.e., scheduling of the task 10 is performed. As a result of the task scheduling, the task #1 of the priority “1” is selected, and the task #1 is executed at the time t3 (Steps S4 and S5). Step S6 in FIG. 2 is executed at the time t4 upon lapse of time duration TH after the time t1, whereby the priority of the task #1 is changed to “3”. Thereafter, scheduling of the task 10 is performed (Step S7), and as a result of the task scheduling, the task #2 of the priority “2” is executed at the time t5 (Step S8).

If it is judged that all the processing with respect to the task #2 are completed at the time t6, the task scheduling is performed again. Specifically, scheduling of the task 10 by the task selector 101, namely, a processing similar to the processing of Step S2 or S7 is executed. As a result, the task #1 of the highest priority at the point of time of the task scheduling is selected, whereby the task #1 is executed during a time duration from the time t7 to the time t8.

Observing the processing during the time interval T from the time t1 to the time t8, the task #1 is executed during the time duration TH from the time t1 to the time t4. Since the priority of the task #1 is set higher than the priority of the task #2 during the time duration TH, the processing of the task #1 is secured during the time duration TH. It should be noted, however, that the time duration from the time t1 to the time t2 during which processing of the OS 100 is executed is sufficiently short, and accordingly negligible. In the case where it is judged that a considerable time is required for processing of the OS 100, it is possible to set the time interval T and the time duration TH accordingly, considering the time required for processing of the OS 100.

If the time required for processing of the OS 100 is negligible, the task #2 is executed during the time duration from the time t4 to the time t6 within the time duration from the time t4 to the time t8, which is the rest of the time interval T other than the time duration TH, and the task #1 is executed during the time duration from the time t6 to the time t8 after termination of the task #2. If it is judged that there is the task #2 to be executed other than the task #1 during the time (T-TH), the task #2 is executed. On the other hand, if it is judged that there is not the task #2 during the time (T-TH), the task #1 is executed. In this way, the task scheduling device 51 is configured such that execution of the task #1 is secured during the time duration TH (from the time t1 to the time t4 in FIG. 3) within the time interval T corresponding to one time cycle, and the processing of the task #1 is allowed to continue if it is judged that there exists no other task to be executed during the time (T-TH) (from the time t4 to the time t8).

As mentioned above, according to the task scheduling device 51 in the embodiment, processing of the specific task is allowed to continue if it is judged that there exists no other task to be executed during the time (T-TH), with a predetermined amount of data processing of the specific task being secured every time interval T. This arrangement enables to efficiently utilize the resource of the CPU 1.

### Example of First Embodiment

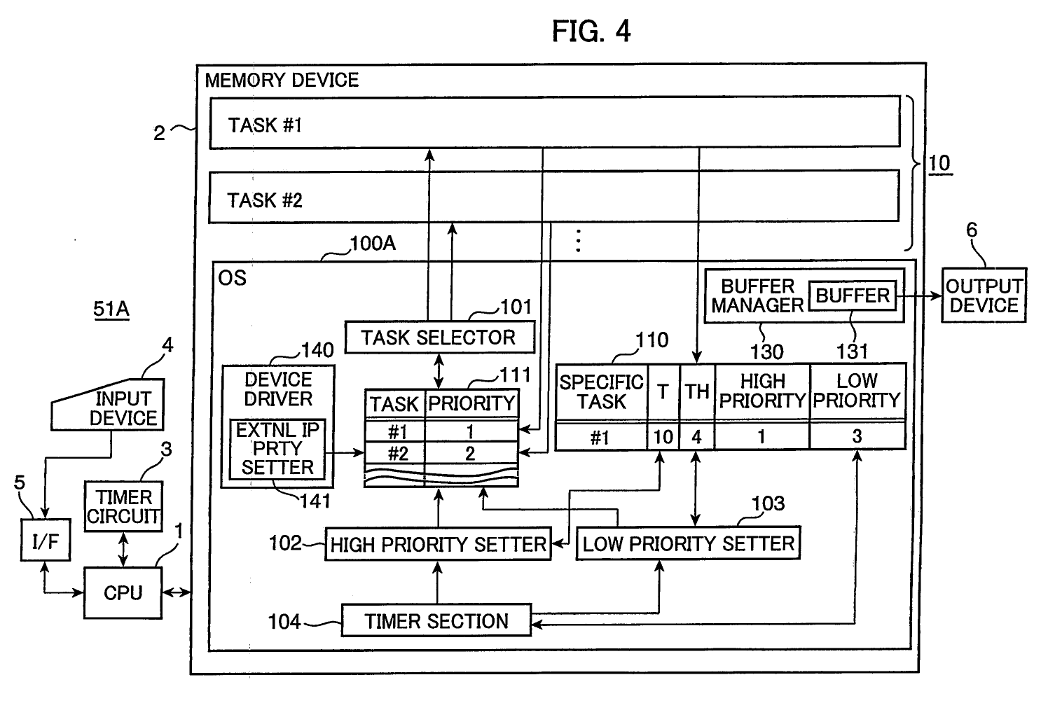

FIG. 4 is a block diagram showing an example of the task scheduling device 51 according to the first embodiment. A computer equipped with the task scheduling device 51A comprises an input device 4, an input interface 5, and an output device 6, in addition to components equivalent to the components of the computer shown in FIG. 1. The input device 4 is a keyboard, and the output device 5 is a display for outputting audio and displaying images, for instance.

An OS 100A for realizing the task scheduling device 51A in cooperation with a CPU 1 includes a buffer manager 130 and a device driver 140, in addition to components equivalent to the components of the OS 100 (see FIG. 1). The buffer manager 130 manages a buffer 131 provided in a memory region of a memory device 2. The buffer 131 temporarily stores data sent from a task #1 before outputting to the output device 5. The buffer manager 130 is constructed as a system call, for instance. In this example, in the case where data is written in the buffer 131, the task #1 calls the buffer manager 130 as the system call, and delivers the data to be written in the buffer 131 to the buffer manager 130, as an argument. Then, the buffer manager 130 writes the delivered data into the buffer 131.

The device driver 140 is part of the OS 100A which manages the input device 4, and has an external input priority setter 141. The external input priority setter 141 sets the priority of a given task in response to manipulation of the input device 4 by the user.

Referring to FIG. 4, the task #1 is a task which writes data into the buffer 131. It is necessary for the task #1 to supply data to the buffer 131 at a speed not lower than the speed of reading out the data from the buffer 131 to the output device 6. Otherwise, the data in the buffer 131 is used up, which may cause data output suspension to the output device 6.

In this example, description is made on the premise that the task #1 is recorded in a specific task table 110 as a specific task. Since the priority of the task #1 is kept high during a time duration TH within a time interval T, normally, the data writing speed into the buffer 131 is kept constant. The constant speed corresponds to a ratio of the amount of data processing in the time duration TH to that in the time interval T. Since the priority of the task #1 is set low during the time (T-TH), namely, the rest of the time interval T other than the time duration TH, the task #1 writes the data into the buffer 131, as far as it is judged that there is no other task to be executed during the time (T-TH).

In this way, the task scheduling device 51A secures the required data writing speed into the buffer 131 by keeping the priority of the task #1 high during the time duration TH. Since the priority of the task #1 is set low during the time (T-TH), it is possible for the CPU 1 to execute a task other than the task #1 during the time (T-TH). This arrangement makes it possible to avoid a situation that execution of the other required task is postponed for a long time.

Further, if it is judged that there is no task to be executed other than the task #1 during the time (T-TH), the task #1 is allowed to continue the data writing into the buffer 131 during the time (T-TH). This arrangement enables the data to be accumulated into the buffer 131 even in a case that frequent interrupt or a like operation obstructs securing a sufficient time for execution of the task #1.

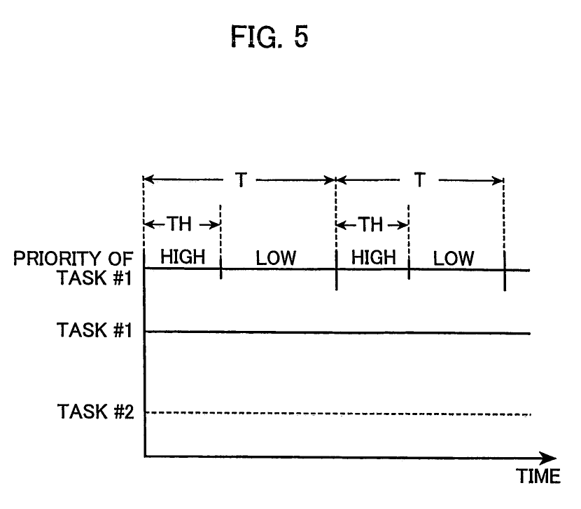

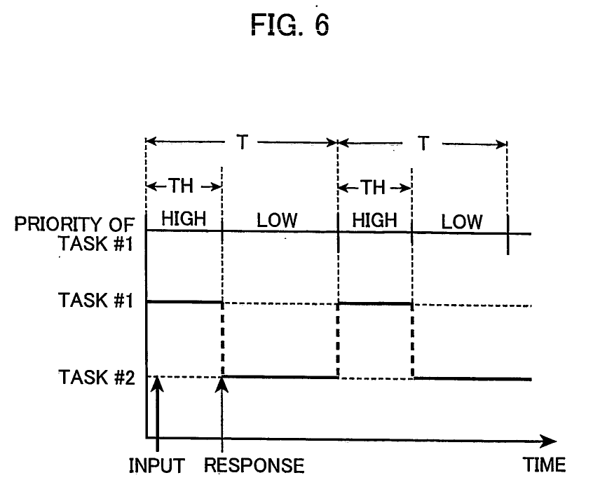

FIGS. 5 and 6 are timing charts for explaining the processing by the task scheduling device 51A. The examples of FIGS. 5 and 6 are described on the premise that the contents in the specific task table 110 and a task priority table 111 are the same as illustrated in FIG. 4, and that the task #2 is a task to be executed in response to manipulation of the input device 4 by the user. Specifically, in response to manipulation of the input device 4 by the user, the external input priority setter 141 sets the priority of the task #2 recorded in the task priority table 111 to “2”, for instance. The contents in the task priority table 111 as illustrated in FIG. 4 are what is set in the task priority table 111 after the priority of the task #2 is set to “2”.

There is no record regarding the task #2 in the task priority table 111 until the external input priority setter 141 sets the priority of the task #2 to “2”. Further, upon completion of the processing of the task #2, the record regarding the task #2 is erased from the task priority table 111. In order to perform this operation, the task scheduling device 51A may be configured such that the task #2 calls a system call associated with the task priority table 111 upon completion of the processing of the task #2, so that the called system call erases the record regarding the task #2 from the task priority table 111.

In view of the above, a task selector 101 is not allowed to select the task #2 as a task to be executed until the input device 4 is manipulated. As a result of the control, as shown in FIG. 5, the processing by the task #1 is allowed to continue. Thereby, the data is securely accumulated in the buffer 131, which reduces likelihood that continuous video or audio output from the output device 6 is hindered.

In response to a predetermined manipulation of the input device 4, the task selector 101 handles the task #2 as a task of the priority “2”. This arrangement enables the task #1 to securely carry out data processing of a predetermined amount, and allows the task #2 to initiate its processing, so that a response is given to the user within the time duration TH after the manipulation of the input device 4, as shown in FIG. 6. If a time duration from manipulation of the input device 4 by the user to start of the execution of the task #2, namely, a response time is exceedingly long, such a long response time may make the user uncomfortable. The task scheduling device 51A enables to realize a short response time which is not longer than the time duration TH, while securing a predetermined amount of data processing of the task #1.

When the processing of the task #2 is over, the task selector 101 no longer selects the task #2 as a task to be executed. Accordingly, the processing by the task #1 is allowed to continue, as shown in FIG. 5.

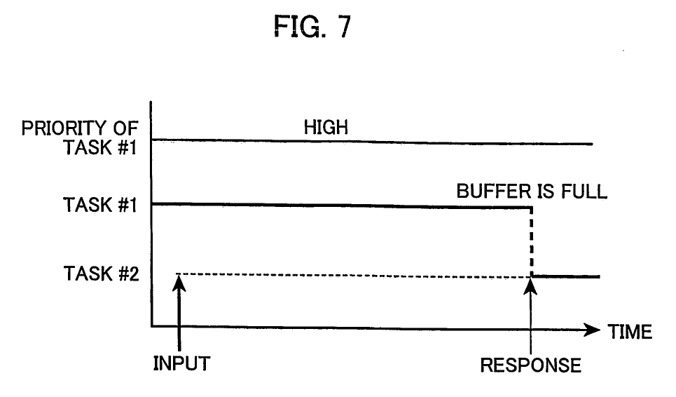

FIGS. 7 through 9 are timing charts for explaining the processing of respective tasks in the case where the task scheduling unique to the embodiment is not performed. Specifically, FIGS. 7 through 9 show processing of tasks based on the conventional task scheduling. In the example of FIG. 7, the priority of a task #1 is fixed to the highest one, i.e., “1”. In this case, execution of the task #1 is continued until a buffer 131 is full of data, even if the priority of a task #2 is set to “2” in response to manipulation of an input device 4 by the user, and the device waits for execution of the task #2 until the buffer 131 is full of data. In such a case, a response time may be exceedingly long, which makes the user uncomfortable.

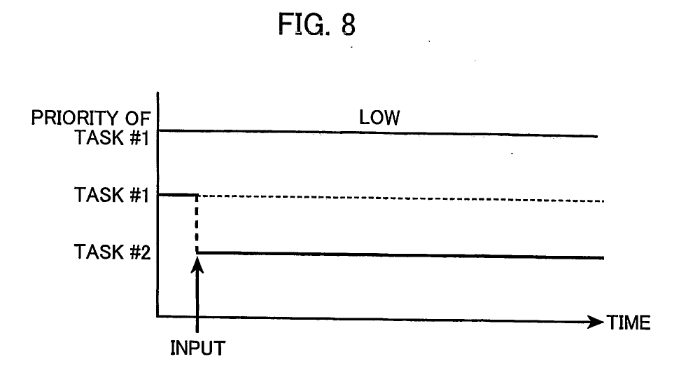

In the example of FIG. 8, the priority of a task #1 is fixed to a low value, e.g., “3”. In this case, when the priority of a task #2 is set to “2” in response to a user's manipulation, execution of the task #1 is immediately suspended, followed by prompt start of execution of the task #2. In this arrangement, since a response time can be relatively shortened, there is less likelihood that the user may feel uncomfortable. However, execution of the task #1 is not resumed until the processing of the task #2 is completed. Therefore, data accumulated in a buffer 131 may be used up before execution of the task #1.

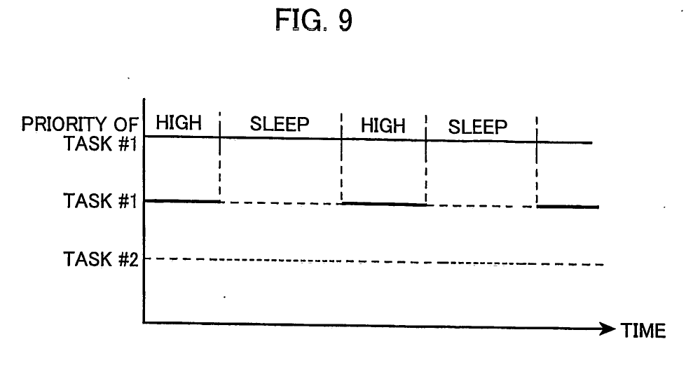

In the example of FIG. 9, a task #1 cyclically repeats sleep and wake-up operations at the high priority “1”. In this case, unless the user manipulates the input device 4, the CPU 1 is in an idle state where there is no task to be executed while the task #1 is put to sleep. In other words, the device encounters waste of resources that data is not accumulated in a buffer 131 despite the fact that a CPU 1 as a resource is available.

On the other hand, the task scheduling unique to the embodiment is advantageous in reducing likelihood that continuous video or audio output is hindered and in shortening the response time.

As an altered arrangement of rewriting the contents in the specific task table 110, it is possible to adopt an arrangement that a buffer manager 130 determines a task that requested data writing into a buffer 131, as a specific task, so that the contents in a specific task table 110 are rewritten, in place of the arrangement that the task #1 calls the system call associated with the specific task table 110. In such an altered arrangement, the buffer manager 130 assigns respective predetermined values to the time interval T, time duration TH, high priority, and low priority to be recorded in the specific task table 110.

### Modification of First Embodiment

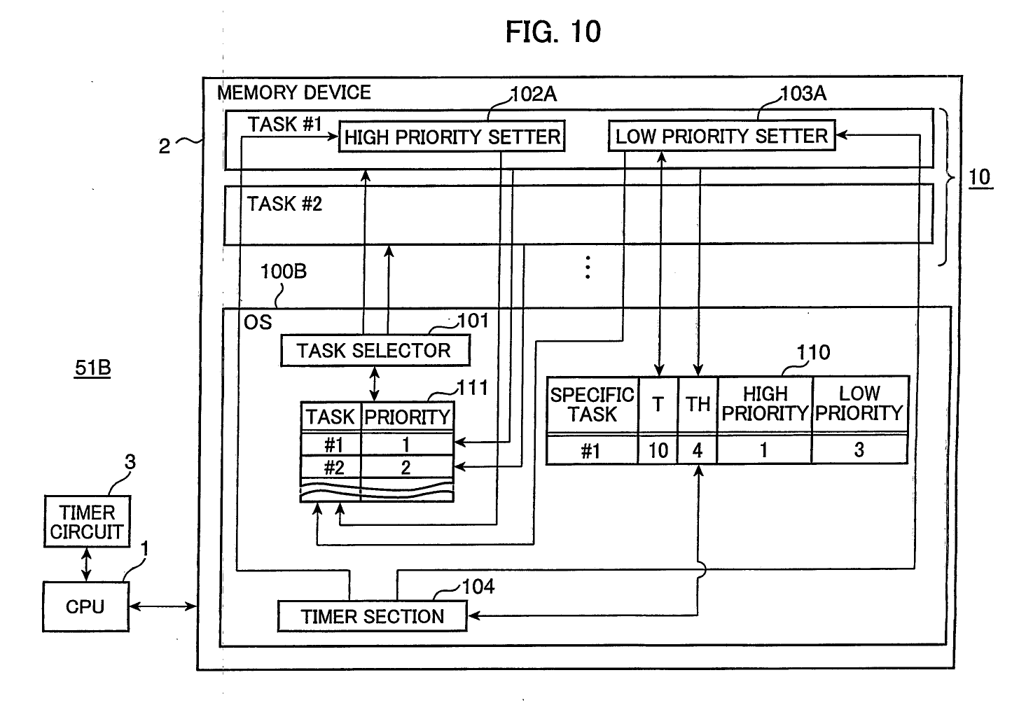

FIG. 10 is a block diagram showing a configuration of a modification of the task scheduling device as the first embodiment. The task scheduling device 51B is different from the task scheduling device 51 (see FIG. 1) in that a high priority periodical setting section 102A and a low priority periodical setting section 103A (hereinafter, simply called as “high priority setter 102A” and “low priority setter 103A”, respectively) corresponding to the high priority setter 102 and the low priority setter 103 of the task scheduling device 51 are provided in a task #1, and that a timer section 104A is provided in place of the timer section 104 in accordance with the alteration of the arrangement. The task scheduling device 51B can be realized by cooperation of respective components of a program including the high priority setter 102A and the low priority setter 103A in the task #1, and respective components of an OS 100B with a CPU 1.

The high priority setter 102A and the low priority setter 103A are each realized as a signal handler which executes processing in response to a signal sent from the OS 100B to the task #1. The signal is generally a mechanism for sending a notification from an OS to a task, and is realized for instance, by changing a variable prepared with respect to each of the tasks.

The timer section 104A refers to a specific task table 110 every time interval T0, and acquires a time interval T and a time duration TH if it is judged that there is a record relating to a specific task, as in the case of the timer section 104. Similarly to the timer section 104, the timer section 104A has a counter, and boots the high priority setter 102A each time when the counted value reaches the time interval T by sending a signal to the high priority setter 102A. The timer section 104A resets the counted value to zero simultaneously with the signal transmission. Further, the timer section 104A boots the low priority setter 103A each time when the counted value reaches the time duration TH by sending a signal to the low priority setter 103A.

The booted high priority setter 102A rewrites the priority “1” assigned to the task #1 in a task priority table 111 to the high priority “1” which has been set in a specific task table 110 by the task #1 itself. Likewise, the booted low priority setter 103A rewrites the priority “1” assigned to the task #1 in the task priority table 111 to the low priority “3” which has been set in the specific task table 110 by the task #1 itself.

A task scheduling equivalent to the task scheduling performed by the task scheduling device 51 is realized by the task scheduling device 51B having the above configuration. In other words, a task selector 101 of the task scheduling device 51B selectively realizes the time scheduling unique to the modified embodiment, and the general time scheduling based on the initial value of the priority appropriately according to needs of the task 10.

### Second Embodiment

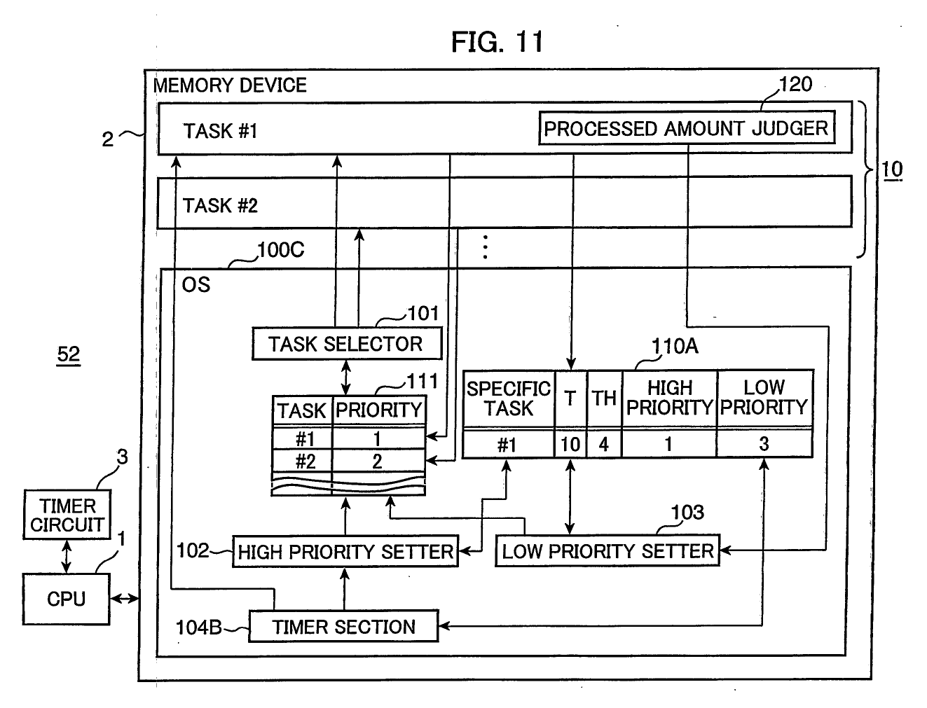

FIG. 11 is a block diagram showing a configuration of a task scheduling device as a second embodiment of the present invention. The task scheduling device 52 constitutes part of a computer. Similarly to the first embodiment, the computer in the second embodiment comprises at least one central processing unit (CPU) 1, a memory device 2, and a timer circuit 3. The computer may be provided with other devices such as an input device and an output device, although illustration of these devices is omitted herein. Further, supply paths of programs and data can be configured in the same manner as the task scheduling device 51 of the first embodiment. The supply paths are not illustrated in FIG. 11.

The task scheduling device 52 is different from the task scheduling device 51 in that the task scheduling device 52 is configured such that switching from a high priority to a low priority is performed based on judgment as to whether a predetermined amount of data processing has been completed, in place of judgment as to whether a predetermined time duration TH elapsed. This arrangement enables a specific task to securely perform data processing of a required amount with high precision. A processed amount judger 120 is written in the memory device 2 for enabling the task scheduling device 52 to perform this operation. In this embodiment, a specific task table 110A is used in place of the specific task table 110 of the task scheduling device 51, and a timer section 104B is used in place of the timer section 104 in accordance with the alteration of the arrangement. In the example of FIG. 11, the processed amount judger 120 is provided in a task #1 which is handled as the specific task. Alternatively, the processed amount judger 120 may be provided in an OS, which will be described later.

The processed amount judger 120 judges whether the processed amount of a specific task (e.g., task #1), which is a task to be scheduled by the task scheduling unique to the present embodiment, has reached a predetermined amount. For instance, if the task #1 is a task handling video streaming data, the processed amount judger 120 judges whether the amount of data processed by the task #1 has reached a predetermined amount corresponding to one frame of video data. If the processed amount judger 120 judges that the processed amount of the task #1 has reached the predetermined amount, the processed amount judger 120 notifies a low priority setter 103 that the processed amount of the task #1 has reached the predetermined amount. Upon receiving the notification from the processed amount judger 120, the low priority setter 103 sets the priority of the task #1, which is a high priority recorded in a task priority table 111 by a high priority setter 102, to the priority (low priority) recorded in the specific task table 110A. Since the task scheduling device 51B does not execute control based on a predetermined time duration TH, the task #1 which is handled as a specific task does not have to record the time duration TH in the specific task table 110A.

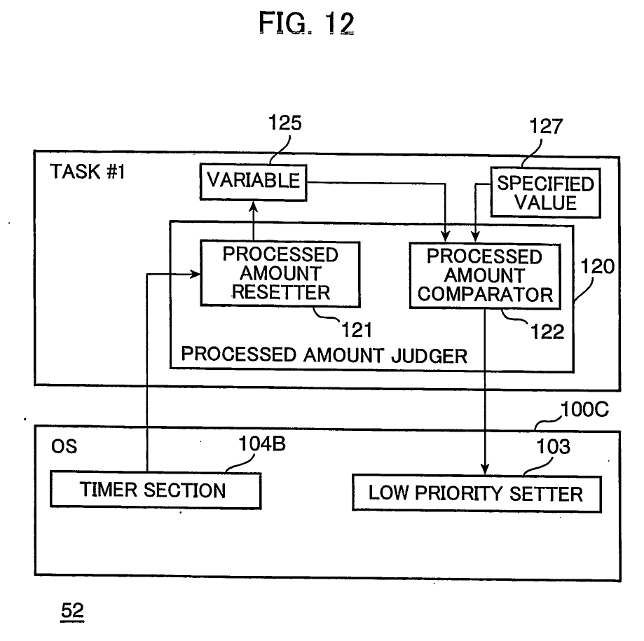

FIG. 12 is a block diagram showing an arrangement relating to a processing of switching the priority of the specific task from a high priority to a low priority in the task scheduling device 52. The processed amount judger 120 has a processed amount resetter 121 and a processed amount comparator 122. The task #1 has a variable 125, and a specified value 127 as a constant. Similarly to the timer section 104, the timer section 104B is realized as an interrupt handler which executes interrupt processing every predetermined time interval T0 (e.g., one-hundredth of the time interval T), which is sufficiently shorter than the time interval T. Similarly to the timer section 104, the timer section 104B has a counter, and sends a signal to the processed amount resetter 121 in the task #1 every time interval T. The processed amount resetter 121 resets the variable 125 whose value is varied with the processing of the task #1, in response to the signal. The variable 125 is a variable that is incremented each time when the task #1 cyclically executes a loop of outputting video data or the like, for instance. For example, in response to output of data of 1 KB each time when processing of the loop is ended, the variable 125 is incremented by a value corresponding to 1 KB (e.g., 1, 1000, 1024, 8192, or the like). Further, the variable 125 is reset to e.g., 0 by resetting.

The processed amount comparator 122 cyclically compares the variable 125 with the specified value 127. For instance, the processed amount comparator 122 makes the comparison each time when the task #1 cyclically repeats the loop. If the variable 125 is not smaller than the specified value 127, the processed amount comparator 122 instructs the low priority setter 103 to change the priority. The specified value 127 is set in advance to a value corresponding to the predetermined amount of data to be processed by the task #1 every time interval T.

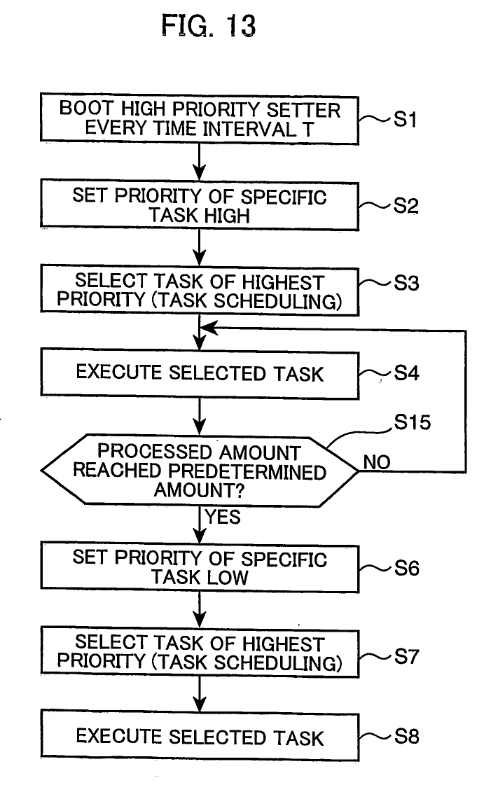

FIG. 13 is a flowchart showing a flow of main processing in performing the task scheduling unique to the second embodiment. Similarly to FIG. 2, description is made on the premise that the specific task table 110 records therein parameters such as a specific task indicator, with the task #1 being designated as a specific task. Processing in FIG. 13 which are equivalent to those in FIG. 2 are denoted at the same reference numerals.

In Step S1, the timer section 104B boots the high priority setter 102. Thereby, the high priority setter 102 initiates its processing. The processing of Step S1 is executed every time interval T. Next, in Step S2, the high priority setter 102 rewrites the priority of the specific task (task #1) recorded in the task priority table 111 to the high priority recorded in the specific task table 110 by referring to the specific task table 110.

Subsequently, a task selector 101 performs scheduling of the task 10 according to the contents in the task priority table 111 (Step S3). Since the priority of the task #1 is set sufficiently high in Step S2, normally, the task selector 101 selects the task #1 as a task to be executed. In Step S4, the CPU 1 executes the task selected by the task selector 101.

Then, in Step S15, the processed amount judger 120 judges whether the processed amount of the task #1 has reached the predetermined amount. Until the processed amount reaches the predetermined amount, execution of the task (task #1) selected in Step S3, i.e., the processing of Step S4 is continued. When the processed amount has reached the predetermined amount, the low priority setter 103 is booted by an instruction from the processed amount judger 120 (Step S6), whereby the priority of the task #1 is set low. Specifically, the low priority setter 103 rewrites the priority (high priority) of the specific task (task #1) in the task priority table 111 to the low priority recorded in the specific task table 110.

Then, in Step S7, the task selector 101 performs scheduling of the task 10. Since the priority of the task #1 is set low in Step S6, the task selector 101 selects a task of priority higher than the priority of the task #1, if it is judged that there exists such a task. On the other hand, if it is judged that there exists no task of priority higher than the priority of the task #1, the task selector 101 continues to select the task #1 as the task to be executed. Subsequently, in Step S8, the CPU 1 executes the task selected by the task selector 101. As mentioned above, the processing in Steps S1 through S4, S15, and S6 through S8 are cyclically repeated every time interval T while the parameters relating to the specific task are recorded in the specific task table 110A.

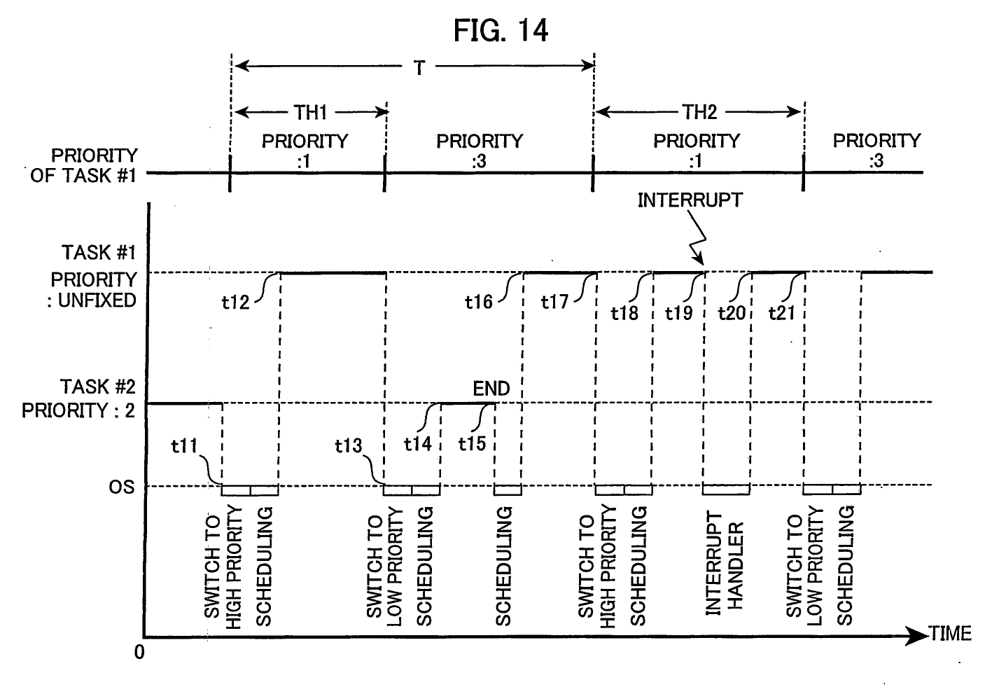

FIG. 14 is a timing chart for explaining an exemplified processing in the second embodiment. In the example of FIG. 14, description is made on the premise that there are two tasks, namely, task #1 and task #2 in the memory device 2, as the task 10. Further, the contents in the specific task table 110 and the initial contents in the task priority table 111 are as illustrated in FIG. 11. Under the above circumstances, the task #1 is a specific task to which the scheduling unique to the embodiment is applied. Although the priority of the task #1 recorded in the task priority table 111 is varied from time to time, description is made on the premise that the priority “3” corresponding to the low priority is assigned to the task #1 at the time 0. The task #2 is a general task, namely, a task other than the specific task, and the priority “2” is fixedly assigned to the task #2, and recorded in the task priority table 111 as such. Similarly to the example shown in FIG. 3, the bold solid line represents that the relevant task is executed by securing the CPU 1, and the blank line segment represents that the processing of an OS 100C is executed by the CPU 1.

The task #2 of the priority “2”, which is higher than the priority “3” assigned to the task #1, is executed at the time 0. However, by execution of Steps S1, S2, and S3 in FIG. 13 at the time t11, the priority of the task #1 is set high, and scheduling of the task 10 is performed. As a result, the task #1 of the priority “1” is selected, and the task #1 is executed at the time t12 (Steps S4 and S5). When the processed amount of the task #1 has reached the predetermined amount at the time t13 after lapse of time duration TH from the time t11, the processing of Step S6 in FIG. 13 is executed, whereby the priority of the task #1 is changed to “3”. Thereafter, scheduling of the task 10 is performed (Step S7), and the task #2 of the priority “2” is executed at the time t14 (Step S8), as a result of the task scheduling.

If it is judged that all the processing with respect to the task #2 are completed at the time t15, the task scheduling by the task selector 101, namely, a processing similar to the processing of Step S2 or S7 is executed. As a result, the task #1 of the highest priority at the point of time of the task scheduling is selected, whereby the task #1 is executed during a time duration from the time t16 to the time t17.

Steps S1, S2, and S3 are executed at the time t17, and the task #1 whose priority is set to “1” is executed at the time t18. In the example of FIG. 14, interrupt is made at the time t19, and an interrupt handler with respect to the OS 100C is executed as a result of the interrupt processing. Execution of the task #1 is resumed at the time t20 after lapse of a certain time duration from completion of the processing by the interrupt handler. When the processed amount has reached the predetermined amount at the time t21 after lapse of time duration TH2 from the time t17, the priority of the task #1 is set to “3”.

The time duration TH2 includes an execution time of the interrupt handler from the time t19 to the time t20. In view of this, the time duration TH2 is longer than the time duration TH1, although the data processing amount of the task #1 is identical to each other between the time durations TH2 and TH1. In this way, in the second embodiment, the time duration during which the priority of the task #1 is set high is unfixed. In the example of FIG. 14, the priority of the task #1 is set high during the time duration from the time t11 to the time 13, and the time duration from the time t17 to the time t21, namely, until the data processing amount of the task #1 reaches the predetermined amount. Thus, execution of the task #1 is secured until the data processing amount of the task #1 reaches the predetermined amount. Further, similarly to the first embodiment, if it is judged that there is a task to be prioritized other than the specific task during the time duration from the time t13 to the time t17, the task to be prioritized is executed. On the other hand, if it is judged that there is no other task to be executed than the specific task during the time duration from the time t13 to the time t17, execution of the task #1 is continued.

As mentioned above, according to the task scheduling device 52 in the second embodiment, processing of the specific task is allowed to continue if it is judged that there is no other task to be executed during the rest of the time interval T other than the time duration TH1 (TH2), with a predetermined amount of data processing of the specific task being secured every time interval T. This arrangement enables to efficiently utilize the resource of the CPU 1.

### Various Modifications of Second Embodiment

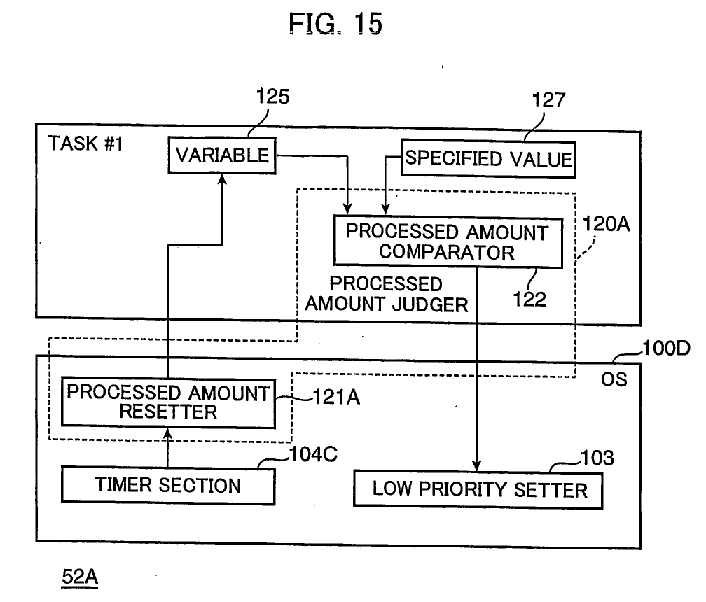

There are proposed various modifications as shown in FIGS. 15 through 19, other than the embodiment shown in FIG. 12, as arrangements relating to a processing of switching the priority of the specific task from a high priority to a low priority. The task scheduling device 52A shown in FIG. 15 is configured such that a processed amount judger 120A is provided in an OS 100D and a task #1 in a bridging manner. Specifically, a processed amount resetter 121A is provided in the OS 100D, and a processed amount comparator 122 is provided in the task #1. Similarly to the timer section 104, a timer section 104C is realized as an interrupt handler which executes an interrupt processing every time interval T0, for instance. The timer section 104C boots the processed amount resetter 121A in the OS 100D every time interval T. Alternatively, the processed amount resetter 121A itself may be realized as an interrupt handler which executes an interrupt processing every time interval T.

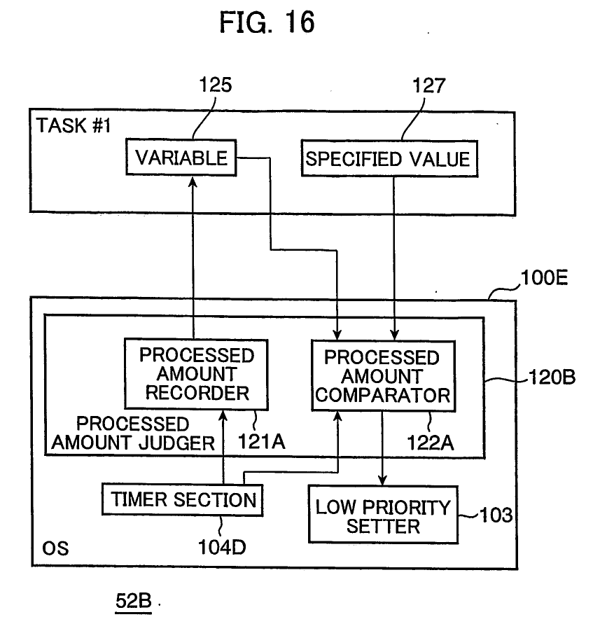

The booted processed amount resetter 121A resets a variable 125 whose value is varied with the processing of the task #1. The processed amount comparator 122 cyclically compares the variable 125 with a specified value 127. When it is judged that the variable 125 is not smaller than the specified value 127, the processed amount comparator 122 instructs a low frequency setter 103 to change the priority of the task.

Whereas in the example of FIG. 15, the processed amount comparator 122 is provided in the task #1, it is possible to provide a processed amount comparator 122A in an OS 100E, as shown by a task scheduling device 52B depicted in FIG. 16. Specifically, it is possible to provide a processed amount judger 120B in the OS 100E. Similarly to the timer section 104, a timer section 104D in FIG. 16 is realized as an interrupt handler which executes an interrupt processing every time interval T0, for instance. Since the timer section 104D has a counter as in the case of the timer section 104, the timer section 104D boots a processed amount resetter 121A in the OS 100E every time interval T, and boots a processed amount comparator 122A every time interval T1. The time interval T1 is an integral multiple of the time interval T0, and is sufficiently shorter than the time interval T. The time interval T1 may be identical to the time interval T0. Similarly to the timer section 104, the timer section 104D has a counter of counting up the time every time interval T0.

The booted processed amount resetter 121A resets a variable 125 whose value is varied with the processing of a task #1. The booted processed amount comparator 122A compares the variable 125 with a specified value 127. When it is judged that the variable 125 is not smaller than the specified value 127, the processed amount comparator 122A instructs a low frequency setter 103 to change the priority of the task. It may be possible to configure a processed amount resetter 121A and a processed amount comparator 122A as interrupt handlers which execute interrupt processing every time interval T and every time interval T1, respectively, in place of the arrangement that the processed amount resetter 121A and the processed amount comparator 122A are booted by the timer section 104D.

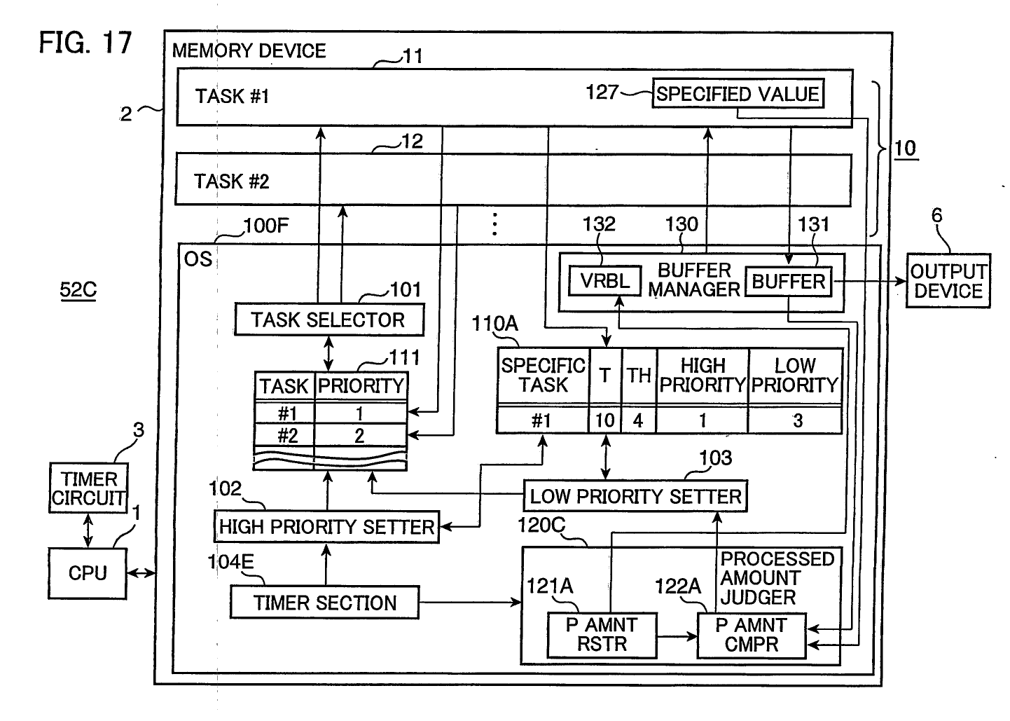

A task scheduling device 52C shown in FIG. 17 is configured such that a processed amount judger 120C provided in an OS 100F refers to the amount of data written in a buffer 131, in place of referring to the variable in the task #1 for determining the amount of processed data. In view of this, a buffer manager 130 increments a variable 132 by a value corresponding to the amount of data written in the buffer 131 each time when the data is newly written in the buffer 131. Further, the processed amount judger 120C has a processed amount resetter 121A and a processed amount comparator 122A. Similarly to the timer section 104, a timer section 104E is realized as an interrupt handler which executes an interrupt processing every time interval T0, for instance.

The timer section 104E boots the processed amount resetter 121A every time interval T, and boots the processed amount comparator 122A every time interval T1. The booted processed amount resetter 121A resets the variable 132. Further, the booted processed amount comparator 122A compares the variable 132 with a specified value 127, and instructs a low priority setter 103 to change the priority of the task if it is judged that the variable 132 has reached the specified value 127.

It is possible to configure a processed amount resetter 121A and a processed amount comparator 122A as interrupt handlers which execute interrupt processing every time interval T and every time interval T1, respectively, in place of the arrangement that the processed amount resetter 121A and the processed amount comparator 122A are booted by the timer section 104E. As a further altered arrangement, it may be possible to cause a buffer manager 130 to boot a processed amount comparator 122A each time when data from a task #1 is newly written into a buffer 131.

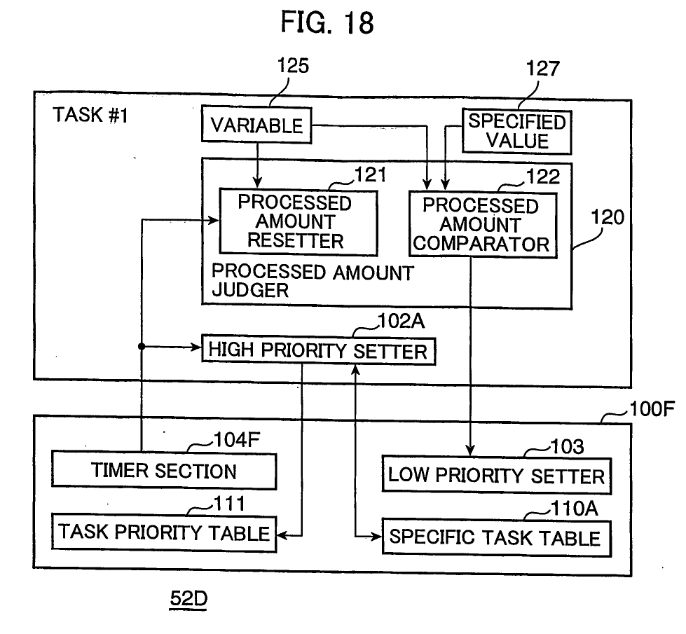

A task scheduling device 52D shown in FIG. 18 is different from the task scheduling device 52 shown in FIG. 12 in that a high priority setter 102A is provided in a task #1. Similarly to the high priority setter 102A in FIG. 10, the high priority setter 102A in FIG. 18 is realized as a signal handler which executes processing in response to a signal sent from an OS 100F to the task #1.

Similarly to the timer section 104B (see FIG. 12), a timer section 104F is realized as an interrupt handler which executes an interrupt processing every time interval T0, for instance. Similarly to the timer section 104B, the timer section 104F has a counter, and boots the high priority setter 102A by sending a signal to the high priority setter 102A each time when the counted value reaches the time interval T. The booted high priority setter 102A rewrites the priority assigned to the task #1 in a task priority table 111 to the high priority which has been set in a specific task table 110A by the task #1 itself Further, similarly to the timer section 104B (see FIG. 12), the timer section 104F boots a processed amount resetter 121 provided in the task #1 by sending a signal to the processed amount resetter 121A every time interval T.

Whereas the task scheduling device 52D shown in FIG. 18 is configured such that a low priority setter 103 is provided in the OS 100F, similarly to the task scheduling device 51B in FIG. 10, it is possible to provide a low priority setter 103A in the task #1.

### Brief Description on the Embodiments

The following is a brief description on the embodiments of the present invention.

(1) A task scheduling device is a task scheduling device for realizing a multitask processing by performing scheduling of a plurality of tasks, the device comprising: a task selector which selects a task of the highest priority among the plurality of tasks, as a task to be executed; a high priority setter which cyclically sets the priority of a specific task among the plurality of tasks to a first predetermined priority every predetermined time interval T; and a low priority setter which cyclically sets the priority of the specific task to a second predetermined priority lower than the first priority before the time interval T elapses and after the priority of the specific task is set to the first priority by the high priority setter.

In the above arrangement, the priority of the specific task is set to the first priority every time interval T, and is set to the second priority before the time interval T elapses. Thus, a time duration during which a relatively high priority is assigned to the specific task, and a time duration during which a relatively low priority is assigned to the specific task are obtained every time interval T. In view of this, the task selector handles the specific task as a task of relatively high priority during the one time duration, and handles the specific task as a task of relatively low priority during the rest of the time interval T other than the one time duration, every time interval T. This arrangement enables to securely execute the processing of the specific task during the one time duration every time interval T by setting the first priority sufficiently high, and to allow the execution of the specific task to continue during the rest of the time interval T if it is judged that there is no other task to be executed during the rest of the time interval T. In other words, this arrangement enables to realize processing of a task to be prioritized, and a task of lower priority in a well-balanced manner, while efficiently utilizing the resource of the CPU.

(2) A task scheduling device is the task scheduling device (1), wherein the low priority setter cyclically sets the priority of the specific task to the second priority upon lapse of a predetermined time duration TH after the priority of the specific task is set to the first priority by the high priority setter, the time duration TH being shorter than the time interval T.

In the above arrangement, the low priority setter sets the priority of the specific task to the second priority upon lapse of the predetermined time duration TH which is shorter than the time interval T after the priority of the specific task is set to the first priority. This arrangement enables to switch over the priority of the specific task with a simplified construction.

(3) A task scheduling device is the task scheduling device (1), further comprising a processed amount judger which judges whether an amount of data processed by the specific task has reached a predetermined amount after the priority of the specific task is set to the first priority by the high priority setter, wherein the low priority setter sets the priority of the specific task to the second priority when the processed amount judger judges that the processed amount has reached the predetermined amount.

In the above arrangement, the low priority setter sets the priority of the specific task to the second priority when the processed amount judger judges that the processed amount of the specific task has reached the predetermined amount. This arrangement enables the specific task to securely process a required amount of data with high precision when the first priority being set sufficiently high.

(4) A task scheduling device is the task scheduling device (3), wherein the processed amount judger includes a processed amount comparator which determines whether the processed amount has reached the predetermined amount by comparing a variable whose value is varied with execution of the specific task with a specified value.

In the above arrangement, the processed amount judger judges whether the processed amount has reached the predetermined amount by comparing the variable whose value is varied with execution of the specific task with the specified value. This arrangement enables to configure the processed amount judger with a simplified construction.

(5) A task scheduling device is the task scheduling device (3), further comprising a buffer which temporarily stores the data outputted from the specific task, wherein the processed amount judger includes a processed amount comparator which determines whether the processed amount has reached the predetermined amount by comparing the amount of data written in the buffer by execution of the specific task with a specified value.

In the above arrangement, the processed amount judger judges whether the processed amount has reached the predetermined amount by comparing the amount of data written in the buffer by execution of the specific task with the specified value. This arrangement enables to make judgment as to whether the processed amount has reached the predetermined amount precisely and easily in the case where the specific task is a task for outputting data.

(6) A task scheduling device is any one of the task scheduling devices (1) through (5), further comprising a task priority table in which the plurality of tasks and the respective priorities thereof are recorded in correlation with each other, wherein the high priority setter cyclically sets the priority of the specific task to the first priority by writing the first priority as the priority assigned to the specific task in the task priority table; the low priority setter cyclically sets the priority of the specific task to the second priority by writing the second priority as the priority assigned to the specific task in the task priority table; and the task selector refers to the task priority table to select the task whose priority is the highest among the plurality of priorities recorded in the task priority table, as the task to be executed.

In the above arrangement, the high priority setter and the low priority setter each sets the priority by writing the priority in the task priority table, and the task selector selects the task in accordance with the priority recorded in the task priority table. This arrangement enables to realize the task scheduling unique to the embodiments with a simplified construction.

(7) A task scheduling device is the task scheduling device (6), further comprising a specific task table in which the specific task, the first priority, and the second priority are recorded in correlation with each other, wherein the high priority setter refers to the specific task table to read out the first priority recorded in the specific task table if information relating to the specific task has been recorded in the specific task table, and to write the readout first priority as the priority assigned to the specific task in the task priority table, and the low priority setter refers to the specific task table to read out the second priority recorded in the specific task table if the information relating to the specific task has been recorded in the specific task table, and to write the readout second priority as the priority assigned to the specific task in the task priority table.

In the above arrangement, the high priority setter and the low priority setter each writes the priority recorded in the specific task table into the task priority table by referring to the specific task table to set the priority. This arrangement enables to realize setting of the priority of the specific task with a simplified construction. Further, execution and suspension of the task scheduling unique to the embodiments can be controlled according to needs by recording the information relating to the specific task in the specific task table or erasing the information from the specific task table.

(8) A task scheduling device is the task scheduling device (7), wherein the specific task writes the information relating to the specific task in the specific task table, and erases the recorded information from the specific task table.

In the above arrangement, since the specific task writes the information relating to the specific task in the specific task table or erases the recorded information from the specific task table, execution and suspension of the task scheduling unique to the embodiments can be controlled by the specific task.

(9) A task scheduling device is any one of the task scheduling devices (1) through (8), wherein at least one of the high priority setter and the low priority setter is realized as a function of an operating system.

In the above arrangement, since at least one of the high priority setter and the low priority setter is realized as the function of the operating system, it is not necessary to provide the at least one of the high priority setter and the low priority setter in the task. In other words, a variety of tasks can be handled in the task scheduling unique to the embodiments.

(10) A task scheduling device is the task scheduling device (9), wherein at least one of the high priority setter and the low priority setter is realized as an interrupt handler.

In the above arrangement, since at least one of the high priority setter and the low priority setter is realized as the interrupt handler, the arrangement for cyclically operating the at least one of the high priority setter and the low priority setter can be realized with a simplified construction.

(11) A task scheduling device is any one of the task scheduling devices (1) through (8), wherein at least one of the high priority setter and the low priority setter is realized as a function of the specific task.

In the above arrangement, since at least one of the high priority setter and the low priority setter is realized as the function of the specific task, the task scheduling unique to the embodiments can be realized without providing the at least one of the high priority setter and the low priority setter in the operating system.

(12) A task scheduling device is the task scheduling device (11), wherein at least one of the high priority setter and the low priority setter is realized as a signal handler.

In the above arrangement, since at least one of the high priority setter and the low priority setter is realized as the signal handler, the arrangement for cyclically operating the at least one of the high priority setter and the low priority setter can be realized with a simplified construction.

(13) A task scheduling method is a task scheduling method for realizing a multitask processing by performing scheduling of a plurality of tasks, comprising: a task selecting step of selecting a task whose priority is the highest among the plurality of tasks as a task to be executed; a high priority setting step of cyclically setting the priority of a specific task among the plurality of tasks to a first predetermined priority every time interval T; and a low priority setting step of cyclically setting the priority of the specific task to a second predetermined priority lower than the first priority before the time interval T elapses and after the priority of the specific task is set to the first priority by the high priority setter.

In the above arrangement, as in the case of the arrangement (1), processing of a task to be prioritized, and a task of lower priority is realized in a well-balanced manner, while the resource of the CPU is efficiently utilized.

(14) A task scheduling program is a task scheduling program for causing a computer to function as a task scheduling device for realizing a multitask processing by performing scheduling of a plurality of tasks, the program causing the computer to function as: a task selecting means which selects a task whose priority is the highest among the plurality of tasks as a task to be executed; a high priority setting means which cyclically sets the priority of a specific task among the plurality of tasks to a first predetermined priority every time interval T; and a low priority setting means which cyclically sets the priority of the specific task to a second predetermined priority lower than the first priority before the time interval T elapses and after the priority of the specific task is set to the first priority by the high priority setting means.

In the above arrangement, as in the case of the arrangement (1), processing of a task to be prioritized, and a task of lower priority is realized in a well-balanced manner, while the resource of the CPU is efficiently utilized.

(15) A recording medium is a computer-readable recording medium recording a task scheduling program which causes a computer to function as a task scheduling device for realizing a multitask processing by performing scheduling of a plurality of tasks, the task scheduling program causing the computer to function as: a task selecting means which selects a task whose priority is the highest among the plurality of tasks as a task to be executed; a high priority setting means which cyclically sets the priority of a specific task among the plurality of tasks to a first predetermined priority every time interval T; and a low priority setting means which cyclically sets the priority of the specific task to a second predetermined priority lower than the first priority before the time interval T elapses and after the priority of the specific task is set to the first priority by the high priority setting means.

In the above arrangement, as in the case of the arrangement (1), processing of a task to be prioritized, and a task of lower priority is realized in a well-balanced manner, while the resource of the CPU is efficiently utilized.

(16) A transmission medium is a transmission medium carrying a task scheduling program which causes a computer to function as a task scheduling device for realizing a multitask processing by performing scheduling of a plurality of tasks, the task scheduling program causing the computer to function as: a task selecting means which selects a task whose priority is the highest among the plurality of tasks as a task to be executed; a high priority setting means which cyclically sets the priority of a specific task among the plurality of tasks to a first predetermined priority every time interval T; and a low priority setting means which cyclically sets the priority of the specific task to a second predetermined priority lower than the first priority before the time interval T elapses and after the priority of the specific task is set to the first priority by the high priority setting means.

In the above arrangement, as in the case of the arrangement (1), processing of a task to be prioritized, and a task of lower priority is realized in a well-balanced manner, while the resource of the CPU is efficiently utilized.

This application is based on Japanese Patent Application No. 2003-405376 filed on Dec. 4, 2003, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

### EXPLOITATION IN INDUSTRY

The task scheduling device, the task scheduling method, the task scheduling program, the recording medium, and the transmission medium according to the present invention are industrially useful because processing of a task to be prioritized, and a task of lower priority is realized in a well-balanced manner, while the resource of the CPU is efficiently utilized.

1-16. (canceled)

17. A task scheduling device for realizing a multitask processing by performing scheduling of a plurality of tasks, the device comprising:
a task selector which selects a task of the highest priority among the plurality of tasks, as a task to be executed;
a high priority setter which cyclically sets the priority of a specific task among the plurality of tasks to a first predetermined priority every predetermined time interval T; and
a low priority setter which cyclically sets the priority of the specific task to a second predetermined priority lower than the first priority before the time interval T elapses and after the priority of the specific task is set to the first priority by the high priority setter.

18. The task scheduling device according to claim 17, wherein the low priority setter cyclically sets the priority of the specific task to the second priority upon lapse of a predetermined time duration TH after the priority of the specific task is set to the first priority by the high priority setter, the time duration TH being shorter than the time interval T.

19. The task scheduling device according to claim 17, further comprising a processed amount judger which judges whether an amount of data processed by the specific task has reached a predetermined amount after the priority of the specific task is set to the first priority by the high priority setter, wherein the low priority setter sets the priority of the specific task to the second priority when the processed amount judger judges that the processed amount has reached the predetermined amount.

20. The task scheduling device according to claim 19, wherein the processed amount judger includes a processed amount comparator which determines whether the processed amount has reached the predetermined amount by comparing a variable whose value is varied with execution of the specific task with a specified value.

21. The task scheduling device according to claim 19, further comprising a buffer which temporarily stores the data outputted from the specific task, wherein the processed amount judger includes a processed amount comparator which determines whether the processed amount has reached the predetermined amount by comparing the amount of data written in the buffer by execution of the specific task with a specified value.

22. The task scheduling device according to claim 17, further comprising a task priority table in which the plurality of tasks and the respective priorities thereof are recorded in correlation with each other, wherein
the high priority setter cyclically sets the priority of the specific task to the first priority by writing the first priority as the priority assigned to the specific task in the task priority table;
the low priority setter cyclically sets the priority of the specific task to the second priority by writing the second priority as the priority assigned to the specific task in the task priority table; and
the task selector refers to the task priority table to select the task whose priority is the highest among the plurality of priorities recorded in the task priority table, as the task to be executed.

23. The task scheduling device according to claim 22, further comprising a specific task table in which the specific task, the first priority, and the second priority are recorded in correlation with each other, wherein
the high priority setter refers to the specific task table to read out the first priority recorded in the specific task table if information relating to the specific task has been recorded in the specific task table, and to write the readout first priority as the priority assigned to the specific task in the task priority table, and
the low priority setter refers to the specific task table to read out the second priority recorded in the specific task table if the information relating to the specific task has been recorded in the specific task table, and to write the readout second priority as the priority assigned to the specific task in the task priority table.

24. The task scheduling device according to claim 23, wherein the specific task writes the information relating to the specific task in the specific task table, and erases the recorded information from the specific task table.

25. The task scheduling device according to claim 17, wherein at least one of the high priority setter and the low priority setter is realized as a function of an operating system.

26. The task scheduling device according to claim 25, wherein at least one of the high priority setter and the low priority setter is realized as an interrupt handler.

27. The task scheduling device according to claim 17, wherein at least one of the high priority setter and the low priority setter is realized as a function of the specific task.

28. The task scheduling device according to claim 27, wherein at least one of the high priority setter and the low priority setter is realized as a signal handler.

29. A task scheduling method for realizing a multitask processing by performing scheduling of a plurality of tasks, comprising:
a task selecting step of selecting a task whose priority is the highest among the plurality of tasks as a task to be executed;
a high priority setting step of cyclically setting the priority of a specific task among the plurality of tasks to a first predetermined priority every time interval T; and
a low priority setting step of cyclically setting the priority of the specific task to a second predetermined priority lower than the first priority before the time interval T elapses and after the priority of the specific task is set to the first priority by the high priority setter.

30. A computer-readable recording medium recording a task scheduling program which causes a computer to function as a task scheduling device for realizing a multitask processing by performing scheduling of a plurality of tasks, the task scheduling program causing the computer to function as:
a task selecting means which selects a task whose priority is the highest among the plurality of tasks as a task to be executed;
a high priority setting means which cyclically sets the priority of a specific task among the plurality of tasks to a first predetermined priority every time interval T; and
a low priority setting means which cyclically sets the priority of the specific task to a second predetermined priority lower than the first priority before the time interval T elapses and after the priority of the specific task is set to the first priority by the high priority setting means.

31. A transmission medium carrying a task scheduling program which causes a computer to function as a task scheduling device for realizing a multitask processing by performing scheduling of a plurality of tasks, the task scheduling program causing the computer to function as:
a task selecting means which selects a task whose priority is the highest among the plurality of tasks as a task to be executed;
a high priority setting means which cyclically sets the priority of a specific task among the plurality of tasks to a first predetermined priority every time interval T; and
a low priority setting means which cyclically sets the priority of the specific task to a second predetermined priority lower than the first priority before the time interval T elapses and after the priority of the specific task is set to the first priority by the high priority setting means.
